(19) United States
(12) Patent Application Publication
(10) Pub. No.: US 2004/0202753 A1
(43) Pub. Date: Oct. 14, 2004

(54) Dipping cups having increased structural rigidity and arcuate corners

(76) Inventors: Douglas J. Jackels, Maple Grove, MN (US); David J. Smith, Le Sueur, MN (US)

Correspondence Address: Michael C. Maier, Esq., P.O. Box 1113, Minneapolis, MN, 55440, US

(21) Appl. No.: 10/409,221

(22) Filed: Apr. 8, 2003

(51) Int. Cl. A23B 4/00

(52) U.S. Cl. 426/120

(57) ABSTRACT

The present invention relates to an assembly having a series of separable sauce cups for use in providing a condiment for a food product. The assembly is provided in a packaging configuration with food products such as waffles, pancakes, toaster pastries and the like and is sized and configured so as to be easily removable by the consumer. The assembly is suitable for use in extreme environments such as encountered in freezer to oven applications.

### CROSS-REFERENCES TO RELATED APPLICATIONS

None.

### FIELD OF THE INVENTION

The present invention relates to an improved disposable dipping or sauce cups, that are connected in series, and which are used to contain sauces, spices, condiments or the like. The sauce cups of the present invention are capable of undergoing extreme temperature conditions such as between freezer to microwave. Such cups are usually provided in connection with consumer products intended for human consumption and in the present instance accompany breakfast foods, such as waffle sticks, pancakes and the like.

### BACKGROUND OF THE INVENTION

Consumers today demand convenience, not only with respect to foods that are easily prepared and ready to eat but also product offerings that are convenient to serve. In an attempt to meet these ever increasing and demanding interests of the consumer, the challenge of the manufacturer is to deliver a high quality product, at good value, that leaves the customer with a pleasing experience so that the consumer will make repeat purchases of the product. In an effort to complement such offerings, manufacturers have begun to include seasoning packages, containers for condiments and sauces and the like. With the advent of such accessories for food products so come the difficulties of making sure the auxiliary containers, packages, etc. are convenient to use as well, otherwise the consumer will simply discard the product.

Complicating the situation for the manufacturer is that containers, packages, etc. for food product must meet standards such as those set forth in 21 CFR 168.180 and for direct food packaging, 21 CFR 177.1520.

Providing food to consumers in convenient portions has long been a challenge. In the case of sauces and other food materials that accompany comestible articles, individual portions have long been prepared. For example, U.S. Pat. No. 1,168,731 discloses a jelly container formed in the shape of an assembly, having a number of individual receptacles in which the jellies are deposited and sealed. The base plate has indentations or perforations that can provide for easy separation of the receptacles. The assembly is formed of a fibrous or analogous material, suitably impregnated so as to render it fit for the storage of jellies.

Another compartmentalized container unit is disclosed in U.S. Pat. No. 3,520,439, which is formed from a self-supporting but frangible material and comprises a plurality of compartments or cells. At least one separation cut is formed between adjacent compartments. The container unit may be formed from a plastic like material, and may be molded from expanded polystyrene. The container unit as shown in this patent has long cuts, represented by reference numeral 6 in the drawings, formed in the container, with the compartments being interconnected by small portions, represented by reference numeral 7 in the drawings, of material. The compartments are releasably secured to one another by a pair of lengths of contact adhesive coated tape, represented by reference numeral 8 in the drawings, adhered about the upper peripheral edge portions of the sidewalls.

A still further food product container is disclosed in U.S. Pat. No. 5,786,011, which comprises a central section, peripheral sections and individual cavities to contain small portions of food product. Each cavity of the body overlaps the central section and one of the peripheral sections, which are linked via a weakening line that permits detachment of the two sections. The detachment allows for the removal of the food item from the cavity. The line of weakening thus divides the cavity itself, and is not a separation of the cavities that allows for separation of the food items from the multi-portion container without opening the cavity.

Some of the drawbacks that the foregoing constructions suffer from are that they can become crushed or flattened while being transported from manufacturing point to filling point to assembly point or during the packaging operation, particularly when the container or package is part of a high speed operation. In addition, many containers today are square or rectangular and as such, the consumer cannot extract the sauce that becomes caught or trapped in the corners of the container or assembly, without inverting the assembly, thus leading to spills and unwanted mess. This can be particularly frustrating near the end of the serving, as there is not enough accessible sauce to coat the food product.

Other drawbacks that are common among packages that provide food products and condiment packages is that the consumer is forced to have to “fish” out the condiment container from the bottom of the package. This can lead to the consumer distorting or ruining the external package or the food product contained within the package. In addition, sauce cups that are available today, generally cannot accommodate one of the length or width of a food product that the sauce cup is intended to compliment. This requires the consumer to only dip the corners of the food product in the cup or the consumer must bite portions of the food product so that the product will be capable of fitting within the cup.

As such, what is needed, is a more rigid container that suffers less crushing during the handling or packaging operation as well as to provide a dipping assist to facilitate removal of the sauce, condiment or the like from the container, cell or cup.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one embodiment of the present invention, a plurality of condiment supply containers are provided. Each of the containers has a base portion with a raised area or detent that extends upwardly from the base. The detent extends substantially upwardly of the entire area of the base portion. The containers are provided with end walls and side walls, each of the walls have a top and bottom edge as well as side edges that are joined one to another along the side edges. The walls are joined to the base portion along the bottom edges to create a receptacle suitable for accepting the condiments or sauces. Along the top edges of each of the walls is a top portion, which extends outwardly from the top edges of each of the walls. The top portion has a centrally disposed opening that corresponds substantially to the base portion.

Each of the walls of the receptacle are provided with a plurality of protuberances that extend longitudinally and slightly outwardly of the walls, away from the interior of the receptacle. The protuberances serve to add structural rigidity to the receptacle to avoid being crushed or flattened during packaging, handling or distribution. While most of the walls intersect with one another at right angles, one of the intersection points or corners is provided in an arcuate configuration so as to enable the consumer of the food product to sweep the sauce or condiment from the receptacle. Each of the containers has a length, width and depth that can accommodate a length or width of a food product.

In a further embodiment of the present invention a series of food products are provided in connection with a complimentary sauce cup assembly are provided and include a package having a height, width and length for containing a food product and a sauce cup assembly. The food products, such as waffles, toaster pastries, pancakes and the like have a length and a width. The sauce cup assembly, that is provided in the package has a series of individually separable cups that has a length, height and a width. In order to facilitate the packaging of the assembly and food product, the length and wide of the assembly are substantially equal to the length and width of the food product when inserted into the package and the height of the assembly is less than a majority of the height of the package.

In a still further embodiment of the present invention a package is described and includes at least one consumable breakfast product, said consumable breakfast product having a length, width and thickness. In addition, a series of interconnected sauce cups, each of the sauce cups are capable of detachment from the series and each of the sauce cups having a length, width and depth. The length and width of each of the sauce cups is substantially equal to the thickness and of the one consumable breakfast product, such that the one consumable breakfast product may be easily inserted in the sauce cup.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a plan view of the present invention;

FIGS. 2A and 2B provide side and end elevation views of the present invention;

FIG. 3 illustrate an isometric view of the present invention;

FIG. 4 shows a further isometric view of the present invention having a seal or covering provided over the individual receptacles and assembly;

FIG. 5 provides for the removal of one of the receptacles from the assembly of the present invention;

FIG. 6 shows an individual receptacle separated from the assembly;

FIG. 7 depicts a individual receptacle with the cover or seal partially removed;

FIG. 8 illustrates a food product being dipped into the filled receptacle of the present invention;

FIG. 9 is an end view of the package showing the assembly and food product contained within the package; and

FIG. 9A is a side view of the package illustrating the assembly and food product contained within the package.

### DETAILED DESCRIPTION OF THE INVENTION

The present invention is now illustrated in greater detail by way of the following detailed description, but it should be understood that the present invention is not to be construed as being limited thereto.

The dipping cups of the present invention provide substantial benefit to both the manufacturer and the consumer of prepackaged food products. Specifically, the present invention enables a low cost system for packaging sauces or condiments in individual portions, that are detachable from a larger connected assembly or grouping of cups, whereby such portions may be handled in a bulk manner, while still allowing the portions to be easily available for individual service. The larger assembly or grouping of the cups is sized and configured to meet the packaging needs of the food products of the present invention.

For example, the present invention is directed to a food products normally consumed for breakfast, such as waffles, toaster pastries and the like. The assembly of individual cups has a width and length, which is approximately equal to the packing length and width of the food product. That is, if waffles have a width of 4-5 inches and a length of 6-7 inches (the length of two waffles placed end to end or a series of waffle sticks adjacent one another and placed end to end) then the assembly of sauce cups has a length and width that is approximately equal to the food product.

With respect to manufacturing, the dipping cups of the present invention provide easy processability, because multiple individual portions may be handled as a unitary article. That is, the dipping cups of the present invention hold together when exposed to certain incidental forces that would tend to separate the receptacles. This enables the dipping cups to be handled by automated processing equipment and conveyed to appropriate destinations for packaging insertion without breaking apart or separating during handling. Further, a unitary dipping cup assembly that includes a plurality of individual portions provides for easier handling of the sauce or condiments, because a larger assembly tends to be easier to mechanically manipulate than smaller individual portions.

An added benefit of the unitary dipping cup assembly of the present invention is the immobilization of individual sauce portions in the package of the combination product comprising sauce portions and comestible articles in the product packaging. As the individual receptacles containing sauce are connected to each other, there is less shifting in the product packaging of items contained therein. The reduction in shifting provides a more consistent product appearance upon opening of the package by consumers, and reduction of product damage (to either the sauce portions or the comestible articles) caused by shifting or instability of items within the combination product package. The unitary aspect of the dipping cup assembly provides significant quality control capabilities of the overall product.

In addition, each of the individual cup portions has a series of longitudinally and slightly outwardly extending (away from the interior of the receptacle or cup) protuberances that provide for structural support of the dipping cup assembly so that the assembly is not flattened during packing, loading, processing or handling.

The present invention also provides convenience to the consumer, because it is now possible to provide a unitary package assembly comprising both the comestible articles together with a suitable sauce for the comestible article together in a single package location. Because the individual receptacles for holding the sauces are attached to one another, there is less opportunity for sauce receptacles to go missing in the home freezer or other storage location. That is, until the individual receptacles or cups are affirmatively removed from the assembly, the remaining cups or receptacles will remain connected one to another.

Additionally, the combination product of the present invention enhances the ability to link any particular sauce with a particular comestible article, thereby providing a unitary and unique product identification. More specifically, the flavor of the sauce may be uniquely matched with the comestible article to provide maximum flavor impact. The present system allows for unique product combinations to be made, and additionally simplifies the matching of the comestible article with the sauce. This is of particular benefit for “do-it-yourself” serving for individuals having difficulty in otherwise preparing such products. For example, the present invention is a particular benefit for do-it-yourself serving by children. Thus, children find it very gratifying and pleasing to be able to go to a single package to obtain their own food product and assemble this product for consumption by them. Further, children seem to be naturally drawn to food products wherein a food article is dipped into an accompanying sauce. As such, the assembly of the present invention simplifies this process for children, in that the assembly of the present invention is made from a substantially rigid material, that is supported by a plurality of longitudinally, slightly outwardly extending protuberances and flanges, thus making it easier to safely handle the sauce-containing receptacle (sometimes referred to as a “dipping cup”) after heating the sauce in a microwave. Likewise, the present dipping cup assembly and combination product provides benefit for certain of the elderly or other people for whom matching of food components can be challenging, or who find such a combination to be highly convenient due to the availability of the single serving size.

The dipping cup assembly of the present invention finds benefit in the embodiment where the product is stored in the freezer and is intended to be heated in the microwave, that is the assembly undergoes a rapid change in condition. The freezer to oven (“FTO”) food preparation embodiment is an extremely convenient and safe product presentation.

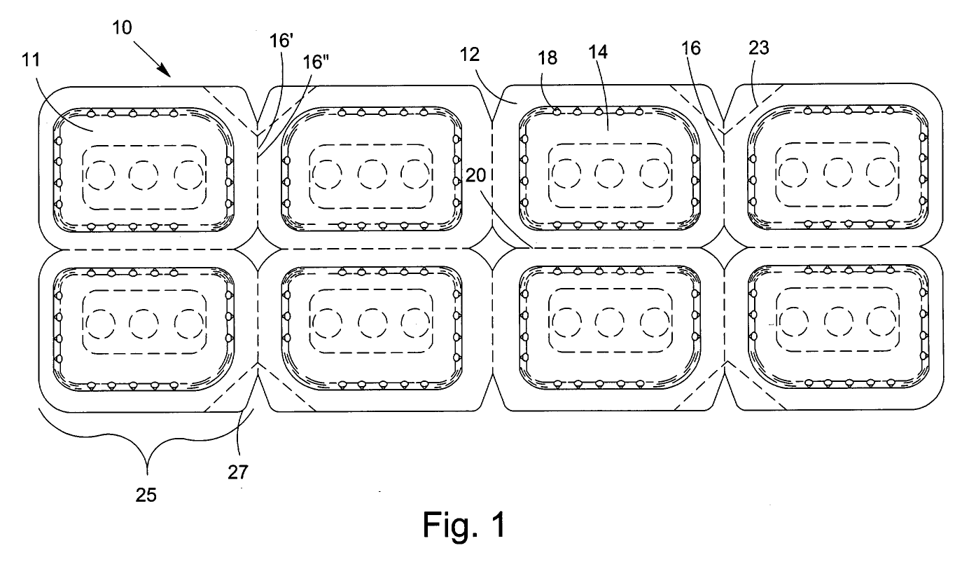

Turning now to FIG. 1 the dipping cup assembly is designated generally by reference numeral 10. As noted above, dipping cup assembly 10 is formed from a substantially rigid material. For purposes of the present invention, a rigid material is any synthetic resin that has been converted into a rigid, polymeric matrix with a closed-cell or open-cell structure, and is sufficiently rigid to substantially hold its shape when filled with a sauce product under both frozen (−10° F.) and hot product temperature (255° F.) conditions. Dipping cup assembly 10 may be formed from a single rigid foam material. The rigid material preferably is generally impervious so as to reduce or preclude migration of the sauce into the rigid material.

The material that is selected for use in the present invention, in addition to meeting the requirements as required in the Code of Federal Regulations (“CFR”), the material cannot create a change in the flavor of the sauce or condiment contained in the receptacle or add additional olfactory properties to the sauce. The material selected for use in the present invention may also contain a small amount of titanium dioxide for whitening.

In preparing the dipping cup assembly of the present invention a rigid material such as polypropylene is selected and undergoes a solid phase pressure forming step under which the material is heat treated at a temperature between 285° F. and 320° F. This processing imparts molecular orientation, increases the stiffness and tensile strength of the formed cup assembly.

A sealing layer, is applied over the top of the dipping cup assembly to retain the sauces or condiments within the individual cup portions, and may be any suitable material for providing sealing functionality, such as an impervious polymeric film that is appropriate for contact with food. Most preferably, the foam material to be used in present invention has a density such that a 20 mil formable web has a density from about 250 to about 320 grams/1000 square inches, and more preferably has a density from about 270 to about 300 grams/1000 square inches.

Dipping cup assembly 10 is safely microwaveable and freezable without becoming excessively brittle. A preferred evaluation of the microwaveability of the assembly 10 is carried out by heating a sauce product in the assembly in a microwave oven, and caramelizing the sauce product to the degree that the sauce product is no longer edible. If the assembly 10 does not substantially deform, and otherwise retains its structural integrity, it is considered to be microwavable by this evaluation.

A preferred evaluation of the brittleness of the assembly upon freezing is carried out by freezing a sauce product in an assembly to a temperature of −10° F., and dropping the frozen product from a height from about three feet. If the assembly does not visibly crack, it is deemed to be to pass this brittleness evaluation. Other preferred rigid foam materials include cross-linked polypropylene, such as TiroFreeze, a foamed polypropylene sheet for frozen food packaging from TiroPak Convenience Food Systems, Bakel, The Netherlands. Still other materials include crystalline polyethylene terephthalate (“CPET”) or polyethylene terephthalate (“PET”). Examples of appropriate materials from which an assembly may be formed are disclosed, for example in U.S. Pat. Nos. 6,063,504 and 6,132,539, the disclosures of which are incorporated herein by reference.

The assembly has a low coefficient of thermal transfer, so that when the sauce is heated to a temperature for consumption, such as 180° F, the assembly containing the sauce will not be uncomfortable to hold in the palm of the hand for time of at least 30 seconds. Preferably, assembly 10 has a thickness of about 2 mm to about 13 mm, depending upon the area or section of the assembly 10. For instance, the corners of the dipping cup range between 2 mm to about 5 mm, and more preferably about 3 mm. The sides range from 7 mm to about 13 mm with about 10 mm being preferred. The bottom of the individual cup assembly ranges from 7 mm to about 13 mm with about 10 mm being preferred.

The material of the assembly is normally provided in sheet form, with the contour of the receptacles imparted by a heat and vacuum mold process as is conventional in the art.

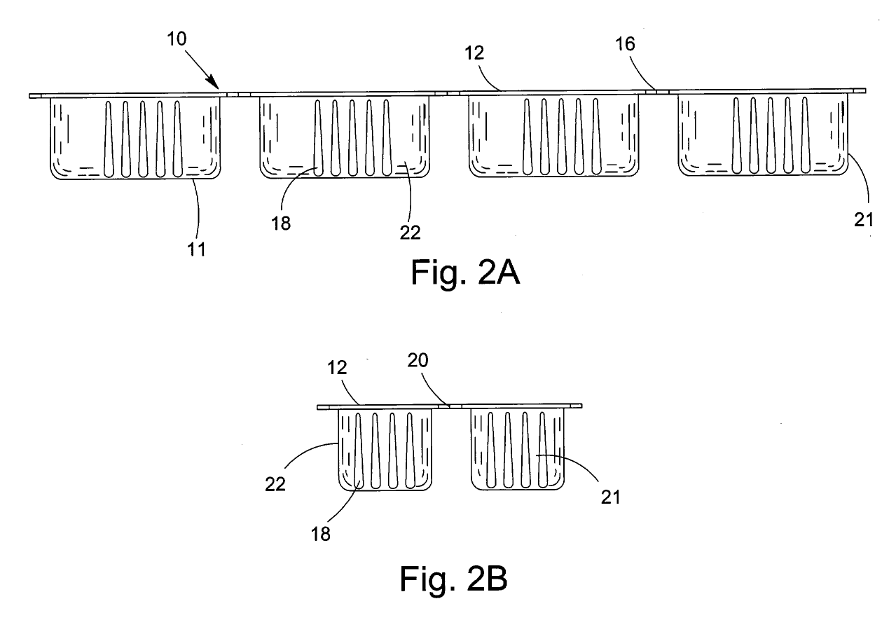

With reference to FIG. 1, a base portion 11 is provided and has a central detent or a portion of the base extending upwardly 14 from a surface on which the base is supported. A top portion 12 is provided on the upper end of the individual dipping cups of the assembly 10. The top portion 12 extends outwardly from the top edges of sidewalls 22 and end walls 21 (referring to FIGS. 2A and 2B). Each of the sidewalls and end walls have a plurality of longitudinally, slightly outwardly extending (outwardly from the interior) protuberances 18 (see FIGS. 2A and 2B).

Line of weakness 16 and 20 are provided on the top surface 12 to create separable dipping cups from the unitary assembly 10. The lines of weakness 16 and 20 are created by perforations that consist of a series of cuts and ties, 16″ and 16′, respectively. In the present invention about 4 to 6 ties are used on the line of weakness 16 and 20. The ties 16′ are sufficiently strong to prevent the premature separation of the cups from the assembly 10. The cuts 16″ are approximately 1/32 of an inch.

Thus, the assembly of the present invention comprises lines of weakness 16 and 20 between individual receptacles 25 such that the consumer can readily separate the individual receptacles 25 one from another by using only tensile force, without the need for separate manipulations such as removal of adhesive tape, flexing the package to further weaken the connection between the receptacles or other such inconvenient steps.

As noted above, the line of weakness holds the receptacles together as a unitary assembly 10 until separation is desired. As such, the receptacles do not separate from each other under tensile forces that generally correspond to the amount of force normally imparted to an assembly 10 when being conveyed by conventional automated packaging equipment. In addition, the receptacles do not separate under the forces encountered when dropping an assembly of sauce from a height of three feet.

The line of weakness 16 and 20 may be any appropriate feature providing an ability to separate receptacles 25 one from another when desired by the consumer. Examples of lines of weakness include, but are not limited to, scoring, lines of perforation and the like. In the case where the line of weakness is a perforation, the perforation may be provided by a knife cut, or may be imparted by heat or laser or other suitable step to provide the cuts.

A preferred assembly 10 arrangement includes a series of substantially rectangular receptacles 25 having a length of about 2.2 inches, a width of about 1.5 to 1.75 inches with about 1.6 inches being preferred and a cup or receptacle depth of about 1 inch or preferably about 0.9 inches. The receptacles 25 of the present invention, and are provided with 2×4 arrangement, that is 2 cups make up the width of the assembly 10 and 4 cups make up the length of the assembly 10.

Each of the top surfaces of the individual dipping cups run about 4 by 6 cm and the depth of the individual dipping cups is about 2 to 2.5 cm. The interior cavity of the dipping cups is about 3 by 4.5 cm.

In addition, each of the receptacles 25 is provided with an arcuate corner 27 which permits the consumer the ability to sweep out the sauce from the receptacle 25 that otherwise would be unusable as the food product, such as a square waffle stick could not reach into the approximately 90° angle of the other three corners.

Turning now to FIGS. 2A and 2B, which provide a side elevation and end elevation views of the assembly 10. As can be seen in FIGS. 2A and 2B the protuberances 18 are provided on the end and sidewalls 21 and 22, respectively. The end walls have 4 protuberances and the sidewalls have 5 protuberances. Also visible is the top surface 12 and bottom surface 11. Lines of weakness or perforations 16 and 20 are also visible but usually would have the cut portion of the ties adjacent the end edge of the top surface 12.

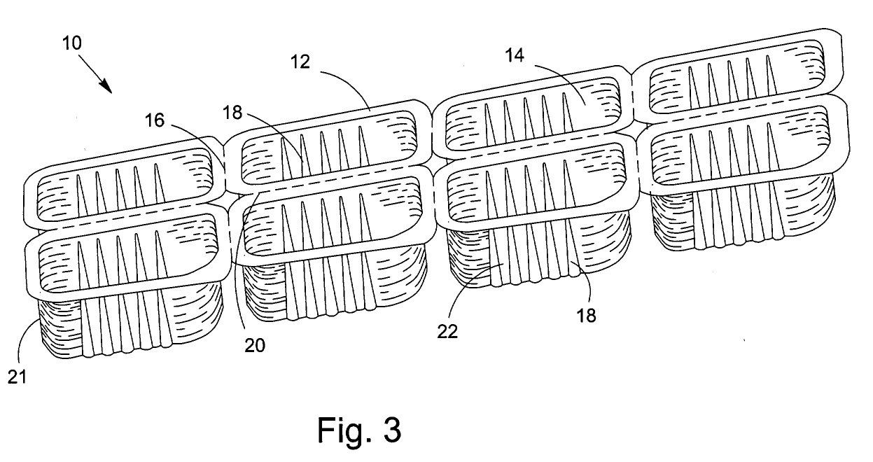

FIG. 3 shows an isometric view of the assembly 10 further illustrating the assembly in a preferred 2×4 arrangement. FIG. 3 shows the protuberances 18 depicted on the sidewalls 22 of the assembly 10.

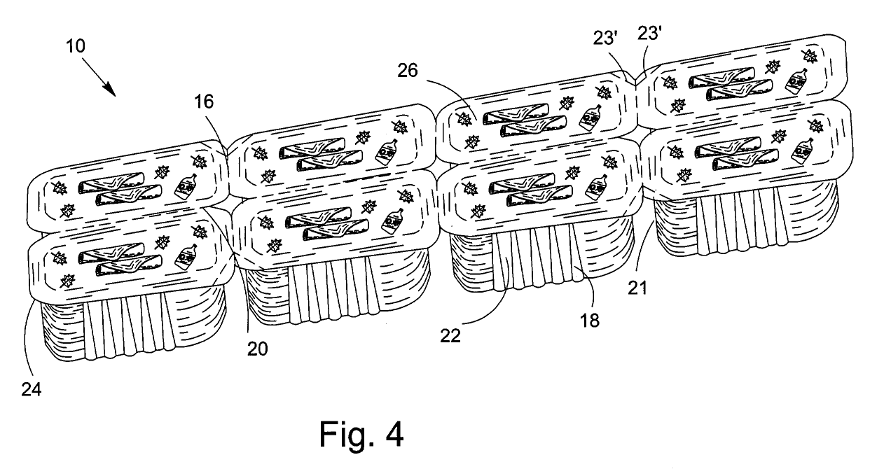

FIG. 4 is an isometric view of the embodiment of the invention as shown in FIG. 1, with a cover sheet 26 applied thereto in a manner to hermetically seal sauce portions (not shown) within recesses of the receptacles 25. When the sauce is provided in the receptacle 25, a cover sheet is affixed over the recess of the receptacle to hermetically seal the sauce therein. The cover sheet 26 is applied to the assembly 10 such that even after separation of the receptacles 25 at the line of weakness 16 and 20, each individual receptacle 25 remains hermetically sealed until the consumer removes the cover sheet 26. The cover sheet 26 may be affixed by any appropriate technique, including but not limited to adhesive bonding, sonic welding, or preferably by heat sealing. U.S. Pat. Nos. 4,700,531; 3,783,089; and 6,042,862 (the disclosures of which are incorporated herein by reference) disclose systems of sealing containers that may be suitable for affixing cover sheets to receptacles.

The cover sheet 26 may be a continuous sheet provided with separation lines corresponding to lines of weakness in the assembly, or may be separate sheets, one for each receptacle. The cover sheet 26 may be any appropriate material for sealing the sauce in a receptacle, including but not limited to a polymeric film, a multi-layer film, a metal foil, laminated foil, and the like. Preferably the cover sheet is made from a material suitable for placing in a microwave oven in the event that the consumer forgets to remove the cover prior to exposing the product to microwave energy. The cover sheet 26 may be transparent, translucent or opaque, and optionally may be provided with indicia thereon.

Application of the cover sheet 26 should be done that in the event the consumer fails to remove the cover sheet 26 prior to placing the receptacle 25 in the microwave oven, the sealing means, is frangible, that is the seal between the top of the receptacle 25 and the cover sheet will break or fracture upon heating or exposing the assembly 10 or individual receptacles 25 to microwave energy so that steam and or pressure can escape from the sauce or the sauce receptacle 25 can vent. This will prevent the sauce from exploding or becoming over heated or the consumer from suffering from steam burns upon removing the cover sheet 26 from the receptacles 25.

Individual cover sheet 26 may optionally be provided with a deformable tab 24, to enable easy grasp of the cover sheet for removal by the consumer. The tab 24 is separable by score lines 23 in the assembly 10 (see FIG. 1) and score lines 23′ in the cover sheet 26 (FIG. 4). The score lines 23 and 23′ enable the consumer to break a piece of the top portion 12 from the assembly 10 to facilitate removal of the cover sheet 26 from the assembly 10.

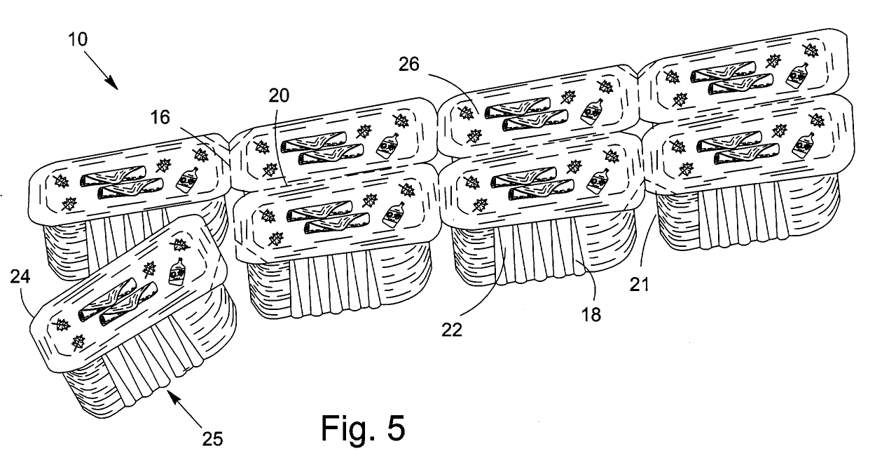

FIG. 5 is a perspective view of the embodiment of the invention as shown in FIGURE. 1, with full cover sheet 26 applied thereto and an individual receptacle 25 being separated from the assembly. As with the individual cover sheets 26, full cover sheet 26 is applied to hermetically seal sauce portions (not shown) within recesses of the receptacles 25. Full cover sheet 26 is provided with separation lines 16 and 20 that generally correspond with lines of weakness 16 and 20 in assembly 10, so that upon separation of receptacles 25 one from another, fill cover sheet 26 is also separated such that individual portions of sauce remain hermetically sealed within each individual receptacle 25.

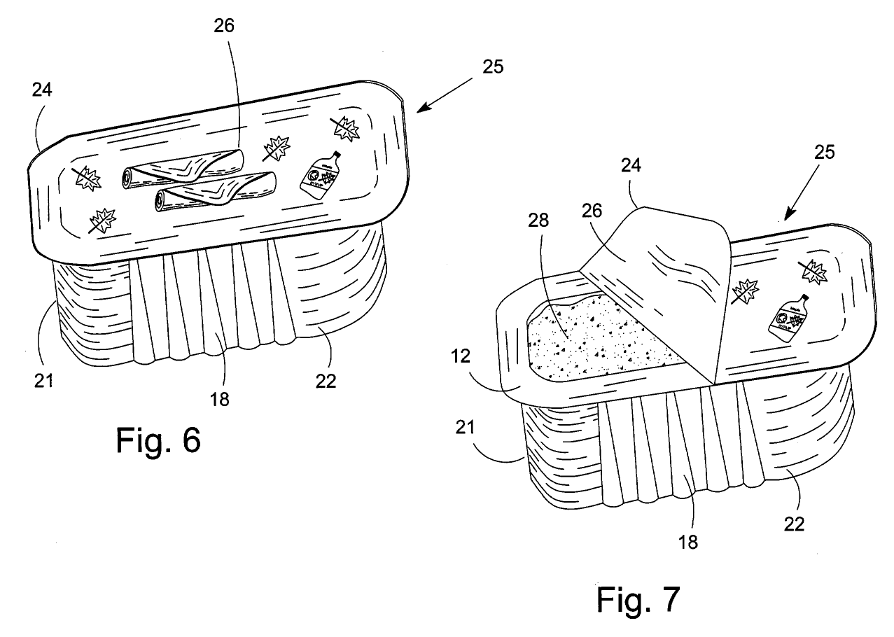

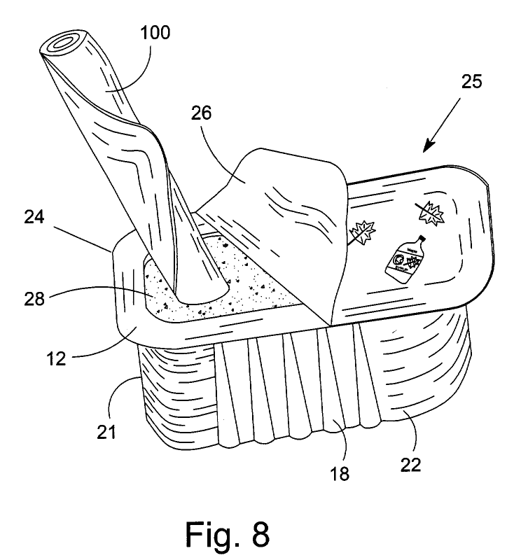

FIG. 6 and FIG. 7 represent views of the individual receptacles 25 that have been separated from the assembly 10. The cover sheet 26 may be provided with indicia illustrative of the contents of the receptacle or the food product that accompanies the assembly 10. Alternatively, the indicia that are provided may include opening instructions, promotional offerings, such as coupons, sweepstakes, or other consumer inducements designed to encourage the consumer to purchase the product. As shown in FIG. 7, the sauce 28 is shown. In the case of breakfast foods such as waffles, pancakes, toaster pastries and the like the sauce or condiment may be syrup, icing, fruit toppings or the like.

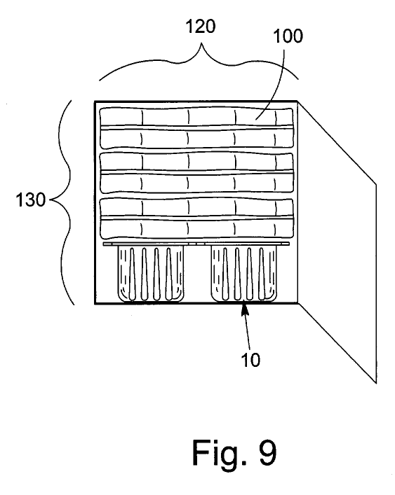

FIG. 8 of the present invention shows a food product 100, here a pancake rolled onto itself being dipped into the sauce 28 after the cover sheet 26 has been removed from the receptacle 25.

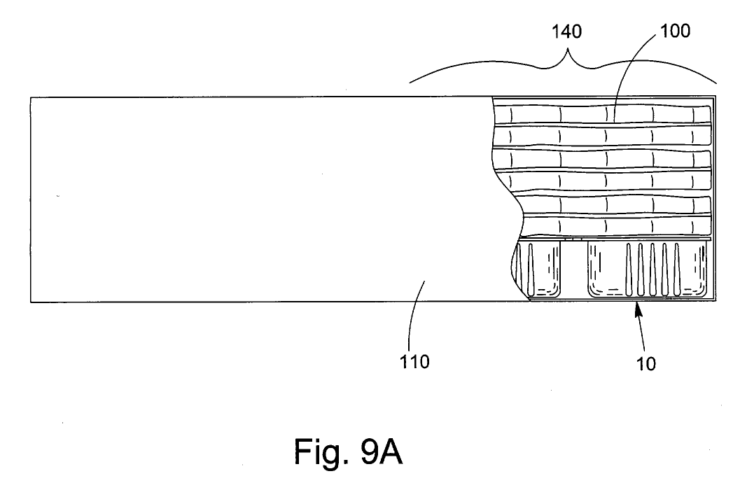

Turning now to FIGS. 9 and 9A, the food product 100 is shown in proximate relationship to assembly 10 and package 110. As shown in FIG. 9, the package with the food products and assembly therein has a width 120, height 130 and length 140. The width 120 and length 140 of each waffle or consumable breakfast product is substantially equal to the length and width of the assembly 10 thereby facilitating the packing of the assembly 10 along with the food product 100 in the package 110.

As depicted in FIG. 9, the height 130 of the package 110 is significantly larger than the height of the assembly 10, that is the assembly 10 makes up less than a majority of the height 130 of the package 110. The term majority as used herein refers to about 50% or less of an area or height of the food package 110. That is, the assembly 10, makes up less than half the height 130 of the package 110.

The assembly 10 of the present invention is designed for accommodating sauces to compliment comestible articles. Most preferably, the assembly receptacle is provided with a geometry that accommodates dipping of the comestible article in the sauce contained therein. For purposes of the present invention a “sauce” is any liquid or semi-solid food item that may be dipped or spread onto a comestible article at the desired combination temperature for consumption by the consumer. The combination temperature is the temperature at which the sauce and the comestible article are combined by dipping or spreading. The combination temperature preferably is about the same temperature that the items are to be eaten, but may be at a lower temperature with subsequent heating for consumption, or may be at a higher temperature for ease of combination, with subsequent cooling before consumption. The sauce may be any sauce suitable for consumption together with a comestible article, and preferably comprises a distinctive flavor to augment the sensory enjoyment of the comestible article. Examples of suitable sauces include sweet sauces, such as fruit flavored sauces in the form of syrups, jams or jellies. A particularly preferred sauce is the syrups conventionally used with breakfast foods, such as maple syrup. Additional preferred sauces are the sweet and sour sauces and honey sauces. Another preferred category of sauces is the savory sauces, such as those comprising cheese, meat, gravy and barbecue flavors. Vegetable-based sauces, particularly the tomato based sauces, such as spaghetti/pizza sauce and ketchup are particularly preferred. Sauces predominant in a seasoning flavor, such as mustard sauce, are highly desired. Additional sauces, such as tartar sauce and butter sauces, find particular advantage in the present invention. Most preferably, the sauce used in the product of the present invention is particularly suited for eating at elevated temperature, i.e. at a temperature between about 120-200° F. Optionally, the sauce may comprise a combination of one or more of the above selections.

The comestible articles 100 to be used in combination products of the present invention may be any appropriate food product that is desirable to be eaten in conjunction with a dipping sauce. Most preferably, the comestible articles are those that may conveniently be stored in a frozen format. Examples of such comestible products include bread products such as breadsticks; batter products such as pancakes, muffins, toaster pastries or waffles; potato products, such as hash browns in any form or French fries; cheese products, such as optionally breaded cheese sticks; meat products, such as chicken nuggets or like meat products; seafood products such as shrimp or fish sticks; vegetable products, such as sliced zucchini; combinations of the above, such as cheese and vegetable blends, for example jalapeno poppers, and the like. The comestible articles may optionally be provided with an outer coating, such as a breading, as desired.

The comestible article may be provided in any shape as suitable for the particular product. For example, meat nuggets are conventionally provided in random geometries generally having a length of about three to six centimeters, a width of about 2 to 4 centimeters and a thickness of about 1 to 2½ cm. Elongated comestible articles are particularly contemplated, preferably having a length of about 5 to 15 centimeters, a width of about 0.5 to 3 centimeters and a thickness of about 0.5 to 3 cm. The present invention in a preferred embodiment, waffle sticks are provided as the food product and are sized and configured such that the width of the waffle stick will readily fit within the width of the dipping cup.

Preferably the amount of sauce in each individual portion is sufficient for providing sauce for a recommended individual serving of the comestible article. For example, if a recommended individual serving of comestible articles is deemed to be 5 to 8 articles, the amount of sauce in each portion is sufficient for satisfactorily dipping 5 to 8 comestible articles in the sauce. Preferably, each portion comprises from 1 to 3 ounces of sauce.

Product packages of the present invention comprise at least two recommended individual servings of the comestible articles, together with their corresponding sauce portions. Preferably, product packages of the present invention comprise at least four recommended individual servings, and more preferably at least six recommended individual servings.

Combination products of the present invention are preferably assembled using automated packaging equipment.

Most preferably, the combination product is stored in the frozen state, i.e. at a temperature below about 32° F. Optionally, the sauce assembly is conveyed for packaging in the frozen state. Most preferably, the combination product comprises foods suitable for microwave heating.

It will thus be seen according to the present invention a highly advantageous dipping cup has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A plurality of separable condiment supply containers provided in an assembly for an edible consumer food product intended for dipping, each of the containers comprising;
a base portion, said base portion having a centrally disposed detent rising upwardly from a surface, said detent covering a substantial portion of said base portion;
first and second side walls and first and second end walls each of which having a top edge, bottom edge and two side edges, said first and second side walls and said first and second end walls being joined to said base portion along each of said bottom edges to form a receptacle for a condiment;
said first end wall being connected to said first side wall along one of said side edges, said first side wall being connected to said second end wall along a second side edge, said second end wall being connected to said second side wall along a side edge and said second side wall being connected to said first end wall along a second side edge;
a top portion being connected to said top edge of each of said first and second side walls and first and second end walls, said top portion having an opening corresponding substantially to said base portion, and said top portion having a flange extending outwardly from said top edge of each of said first and second side walls and first and second end walls;
each of said first and second end walls and said first and second side walls having a plurality of detents extending longitudinally of said walls and slightly outwardly of said walls and running perpendicularly of said base portion, said detents serving to support said receptacle for a condiment;
one of said first and second end walls and one of said first and second side walls meeting at said side edge of each of said walls to form at least one arcuate corner to facilitate sweeping of the condiment from said receptacle; and
wherein, each of said containers being sized and configured to accommodate one of a length or width dimension of a consumable food product.

2. A plurality of separable condiment supply containers as recited in claim 1, wherein the arcuate corner of adjacent containers are adjacent one another.

3. A plurality of separable condiment supply containers as recited in claim 1, wherein, lines of weakness are provided between adjacent containers.

4. A plurality of separable condiment supply containers as recited in claim 3, wherein said line of weakness is a perforation having at least 4 ties.

5. A plurality of separable condiment supply containers as recited in claim 1, each of said plurality of containers is joined to another of said plurality of containers along the top surface of at least one of said first and second sidewalls and one of said first and second end walls.

6. A plurality of separable condiment supply containers as recited in claim 1, wherein each of the separable condiment supply containers is covered with a cover sheet.

7. A plurality of separable condiment supply containers as recited in claim 6, wherein said cover sheet is provided with indicia related to the consumable food product.

8. A plurality of separable condiment supply containers as recited in claim 6, wherein each of the separable condiment supply containers is provided with a deformable tab to enable removal of said cover sheet.

9. A plurality of separable condiment supply containers as recited in claim 6, wherein said cover sheet is secured to each of said separable condiment supply containers through a frangible adhesive to enable venting.

10. A plurality of separable condiment supply containers as recited in claim 1, wherein the assembly is prepared from a polypropylene material.

11. A plurality of separable condiment supply containers as recited in claim 1, wherein the assembly has a thickness ranging from 2 to 13 mm.

12. A plurality of separable condiment supply containers as recited in claim 1, wherein the assembly is provided in a 2×4 arrangement.

13. A plurality of food products and a complimentary sauce cup assembly, comprising;
a package for containing a plurality of food products and a sauce cup assembly, said package having a length, height and width;
each of said food products has a length and a width;
said sauce cup assembly, having a series of individually separable cups, and said assembly having a length, height and a width; and
wherein said length and width of said assembly are substantially equal to said length and width of said food package when inserted into said package and said height of said assembly is less than a majority of said height of said package.

14. A food product as recited in claim 13, wherein said food product is a selected from the group of waffles, pancakes, toaster pastries, and combinations thereof.

15. A food product as recited in claim 13, wherein said assembly is covered with a frangible seal to enable venting upon heating.

16. A package comprising;
at least one consumable breakfast product, said consumable breakfast product having a length, width and thickness;
a series of interconnected sauce cups, each of said sauce cups being capable of detachment from said series and each of said sauce cups having a length, width and depth; and
wherein, said length and width of each of said sauce cups is substantially equal to the thickness and of said one consumable breakfast product, such that said one consumable breakfast product may be easily inserted in said sauce cup.

17. A package as recited in claim 16, wherein said breakfast consumable product includes waffles, waffle sticks, pancakes, toaster pastries and combinations thereof.

18. A package as recited in claim 16, wherein said series of interconnected sauce cups is covered by a seal having indicia related to said consumable breakfast precuts.
